(19) United States
(12) Patent Application Publication
(10) Pub. No.: US 2015/0330718 A1
(43) Pub. Date: Nov. 19, 2015

(54) INTEGRATED BLOWER DIFFUSER-FIN SINGLE PHASE HEAT EXCHANGER

(71) Applicant: HAMILTON SUNDSTRAND CORPORATION, Windsor Locks, CT (US)

(72) Inventors: Brian St. Rock, Andover, CT (US); Ricardo Munoz, South Windsor, CT (US); Eric S. Landry, West Hartford, CT (US); Neal R. Herring, East Hampton, CT (US)

(21) Appl. No.: 14/327,409

(22) Filed: Jul. 9, 2014

Related U.S. Application Data
(63) Continuation-in-part of application No. 14/194,306, filed on Feb. 28, 2014.
(60) Provisional application No. 61/870,907, filed on Aug. 28, 2013.

(51) Int. Cl. F28F 3/02; B23P 15/26

(52) U.S. Cl. CPC F28F 3/02; B23P 15/26

(57) ABSTRACT

A method and apparatus for exchanging heat between two fluids is disclosed. The apparatus includes an integrated blower with a diffuser fin baseplate. The baseplate includes diffuser fins on a surface of the baseplate. The diffuser fins are integrated with the blower. At least one channel is formed in the fins or baseplate for flow of a fluid through the baseplate.

### CROSS-REFERENCE TO RELATED APPLICATIONS

This application claims is a continuation-in-part of application Ser. No. 14/194,306, filed Feb. 28, 2014, which claims priority from U.S. Provisional Application Ser. No. 61/870,907, filed on Aug. 28, 2013, which is incorporated by reference herein in its entirety.

### STATEMENT OF FEDERAL SUPPORT

This invention was made with Government support under Contract Number W31P4Q-09-C-0067 awarded by the United States Army. The Government has certain rights in the invention.

### BACKGROUND

Many industrial systems require efficient exchange of heat from a liquid to a gas, or between two gases. These liquid-gas, liquid-liquid, or gas-gas heat exchangers are known as single-phase heat exchangers when the fluids do not change phase in the heat exchanger, i.e., liquids enter and leave in liquid phase, gases enter and leave in the vapor phase. Heat exchangers exist in a wide variety of applications, including building air conditioning, electronics, aircraft subsystem cooling, and many others. Increased power needs of such applications produces a need for improved heat exchanger design.

### SUMMARY

According to one embodiment of the present invention a method of heat exchanger includes: forming a cooling assembly by integrating a blower with a diffuser fin as a baseplate, wherein the baseplate includes at least one channel formed therein for flow of a fluid through the baseplate; coupling the cooling assembly to an object; and exchanging heat between the object and the fluid flowing in the at least one channel.

According to another embodiment, a cooling apparatus includes: a blower; a baseplate having diffuser fins on a surface of the baseplate, wherein the diffuser fins are integrated with the blower; and at least one channel formed in the baseplate for flow of a fluid through the baseplate.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 shows a heat exchanger or cooling assembly according to an exemplary embodiment of the present disclosure;

FIG. 2 shows a cross-sectional view of a diffuser fin of the cooler assembly of FIG. 1;

FIG. 3 shows various designs for a heat exchanger according to various embodiments of the present disclosure;

FIGS. 4a and 4b show various arrangements for a plurality of heat exchangers in order to produce a selected airflow through the plurality of heat exchangers; and

FIG. 5 shows an illustrative heat exchanger for providing heat exchange between a first gas and a second gas.

### DETAILED DESCRIPTION

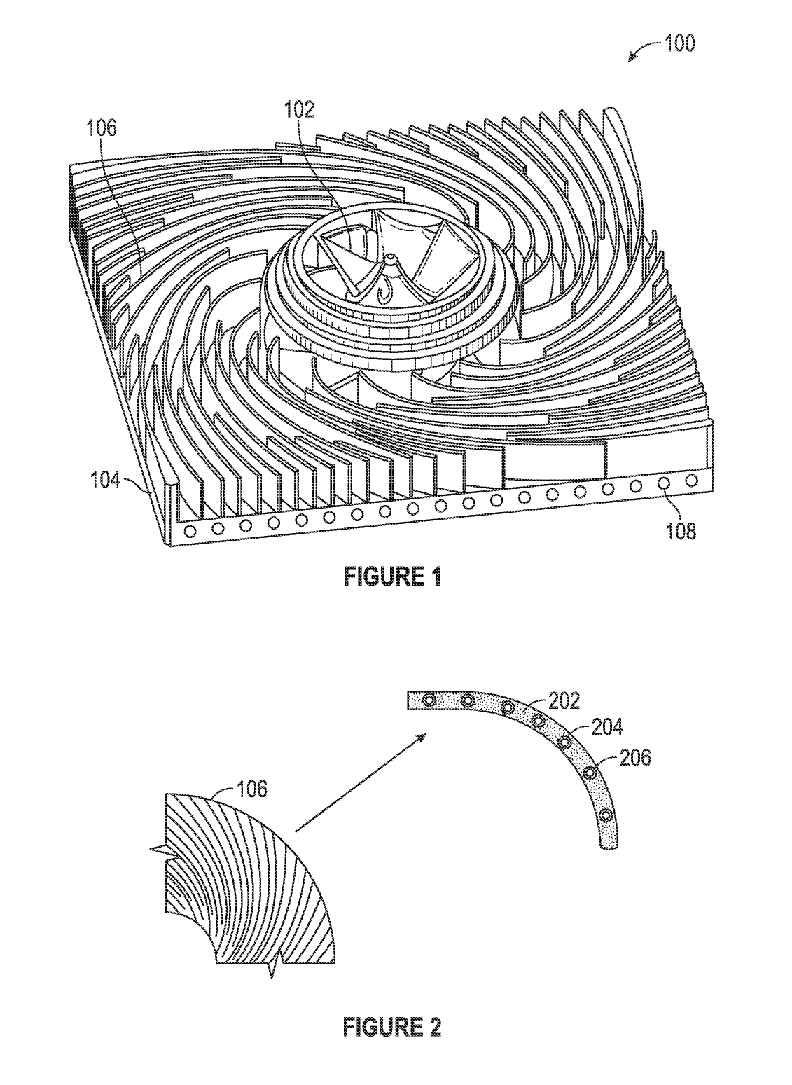

FIG. 1 shows a heat exchanger, also referred to herein as a cooling assembly 100, according to an exemplary embodiment of the present disclosure. The cooling assembly 100 includes a blower 102 coupled to a baseplate 104. The baseplate 104 includes a surface that includes one or more diffuser fins 106. The diffuser fins 106 are integrated with the blower 102 to direct air flow from the blower 102 into the diffuser fins 106 in an efficient manner. The baseplate 102 further includes one or more channels 108 that pass through the baseplate 102 generally in a plane parallel to the surface including the diffuser fins 106. The one or more channels 108 may include a series of channels integrated into the base plate 102. A fluid passes through the one or more channels. The one or more channels may include straight channels, spiral channels, and/or micro channels having various cross-sections.

FIG. 2 shows a cross-sectional view of a diffuser fin 202 of the cooler assembly 100 of FIG. 1. The diffuser fin 202 includes one or more channels 204, 206 flowing within the body of the diffuser fin 202. Liquid or gas passes through the fin 202 through the one or more channels 204 and 206 to pass from the bottom of the selected fin 202 to the top of the selected fin 202, or vice versa. In one embodiment, a channel 108 of the baseplate may be diverted into the body of the diffuser fin 202 to form one of the one or more channels 204, 206. In another embodiment, the channel 108 of the baseplate may have several channels that branch off of the channel 108 to form the one or more channels 204, 206. While the channels 204, 206 are shown having a circular cross-section, the channels 204, 206 may have any suitable cross-section. Fluid in the channels 204, 206 transfers heat to or from the air that is blown through the integrated fin-diffuser. The heat transfer enables thermal resistance on an air-side of the heat exchanger to be reduced in comparison to a conventional heat exchanger.

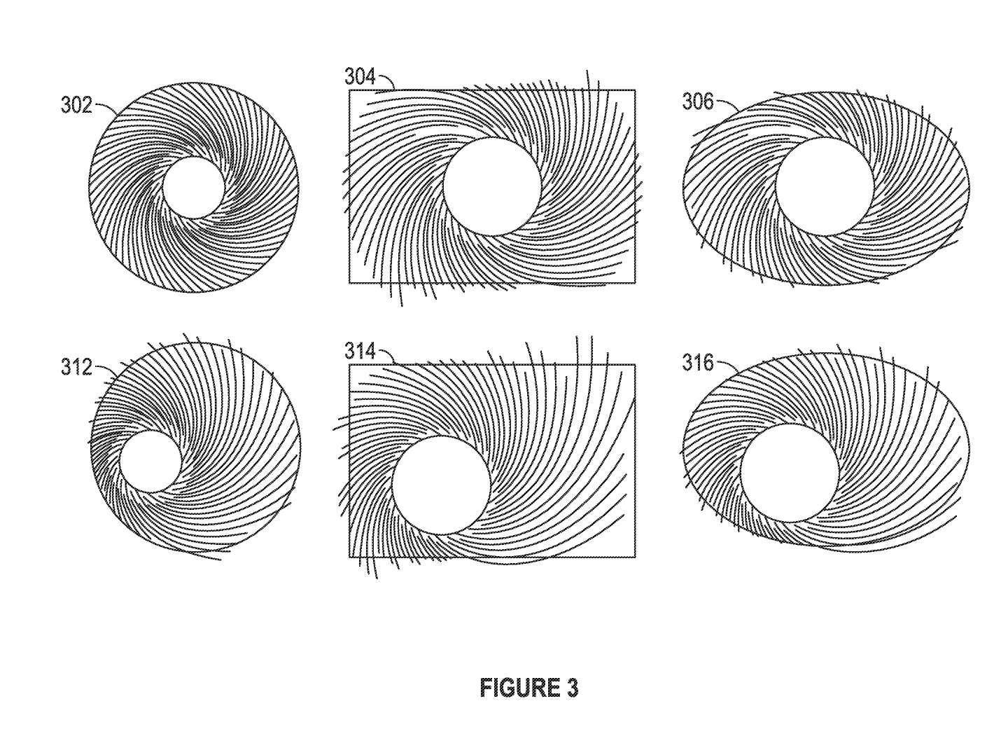

FIG. 3 shows various designs for a heat exchanger according to various embodiments of the present disclosure. The base plate of the heat exchanger may be round (302, 312) rectangular (304, 314) or elliptical (306, 316), as well as other selected geometries. The blower may be centrally located on the base plate (302, 304, 306) or offset from the center (312, 314, 316). Blower offset may be accomplished by matching pressure drops in each channel of the base plate by varying channel geometry across the heat sink. A density of the fins (“the fin density”) may be tailored across the surface of the baseplate in order to control the heat flux profile in the heat exchanger. For example, the fin density may be increased at a location for which the working fluid heat transfer coefficient is high and decreased at locations for which the working fluid heat transfer coefficient is low.

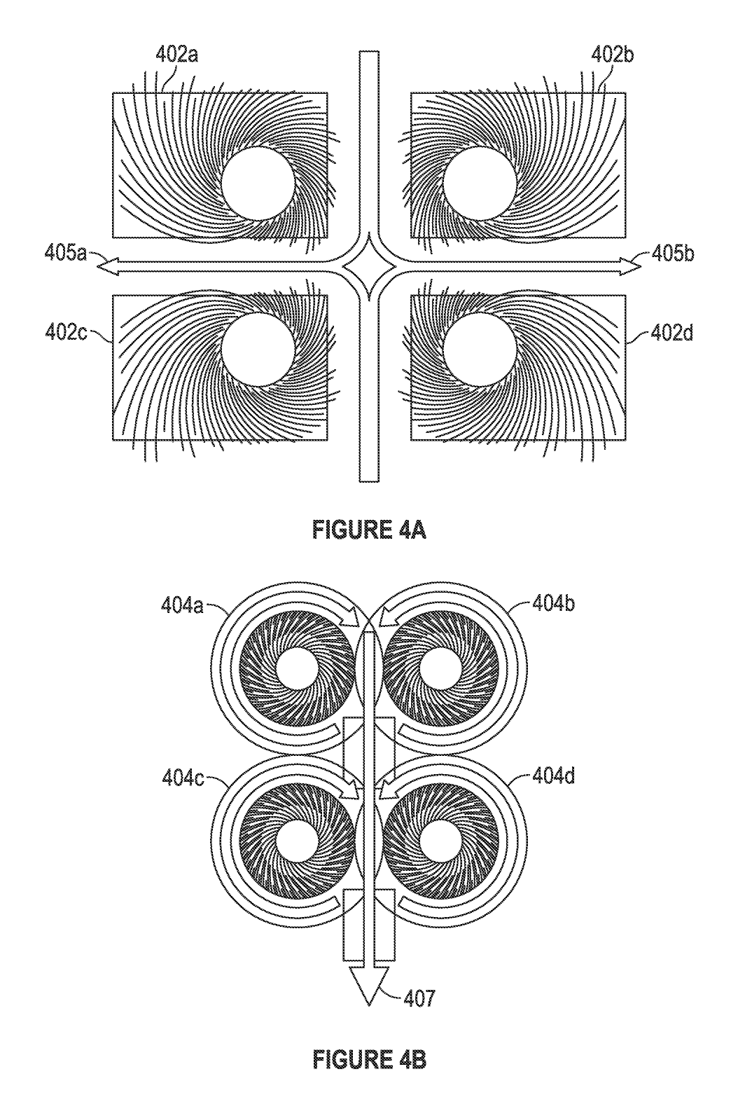

FIGS. 4a and 4b show various arrangements for a plurality of heat exchangers in order to produce a selected airflow through the plurality of heat exchangers. In various embodiments, the plurality of heat exchangers may be arranged in an array in order to allow an increased heat exchanger capacity. In FIG. 4a, the plurality of heat exchangers 402a-d is arranged to promote a flow of air along anti-parallel directions 405a and 405b. In FIG. 4b, the plurality of heat exchangers 404a-d is arranged to promote a flow or air along a selected direction 407. In various embodiments, the flow of air form the exits of the fin-diffusers may be arranged such that additional secondary flow is entrained, thereby enhancing a performance of the heat exchanger.

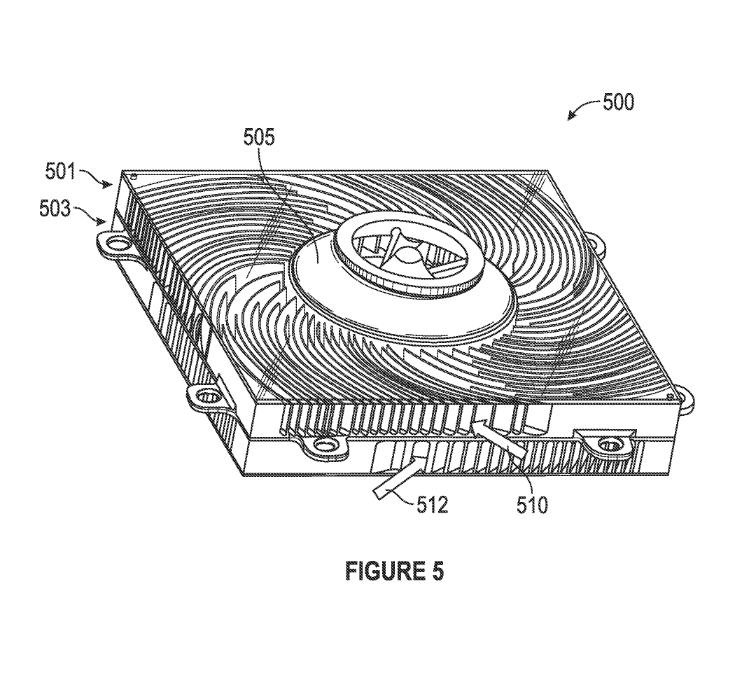

FIG. 5 shows an illustrative heat exchanger 500 for providing heat exchange between a first gas and a second gas. The heat exchanger includes a first fin diffuser level 501 and a second fin diffuser level 503. The blower 505 of the heat exchanger is integrated with both of the first fin diffuser level 501 and the second fin diffuser level 503. A first gas 510 passes through the first fin diffuser level 501 and a second gas 512 passes through the second fin diffuser level 503. Fluid passages may pass through both the fins of the first fin diffuser level 501 and the fins of the second fin diffuser level 503, thereby providing a heat exchange between the first gas 510 and the second gas 512. In another embodiment, the blower 505 may include a first blower associated with the first fin diffuser level 501 and a second blower associated with the second fin diffuser level 503. The first blower may include a first rotary shaft and the second blower may include a second rotary shaft. Alternatively, the first blower and the second blower may share a single rotary shaft.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method of heat exchange, comprising:
forming a cooling assembly by integrating a blower with a diffuser fin of a baseplate, wherein the baseplate includes at least one channel formed therein for flow of a fluid through the baseplate;
coupling the cooling assembly to an object; and
exchanging heat between the object and the fluid flowing in the at least one channel.

2. The method of claim 1, wherein the at least one channel of the baseplate passes from the baseplate through an interior of the fin to flow the fluid through an interior of the fin of the baseplate.

3. The method of claim 2, wherein the baseplate includes diffuser fins on opposing surfaces of the baseplate, wherein a fluid channels passes through a first diffuser fin on one surface of the baseplate and through a second diffuser fin on the opposing surface of the baseplate to transfer heat from a first gas in contact with the first diffuser fin to a second gas in contact with the second diffuser fin.

4. The method of claim 1, wherein the blower is offset from a center of the baseplate.

5. The method of claim 1, further comprising arranging a plurality of cooling assemblies to produce a selected air-flow pattern with respect to the plurality of cooling assemblies.

6. The method of claim 1, wherein the fluid is a single-phase heat transfer fluid.

7. The method of claim 1, further comprising at least one of: (i) transferring heat from the object to the fluid; and (ii) transferring heat from the fluid to the object.

8. A heat exchanger, comprising:
a blower;
a baseplate having diffuser fins on a surface of the baseplate, wherein the diffuser fins are integrated with the blower; and
at least one channel formed in the baseplate for flow of a fluid through the baseplate.

9. The heat exchanger of claim 8, wherein a fin of the baseplate further includes a channel for flow of the fluid through the fin.

10. The heat exchanger of claim 9, wherein the baseplate includes diffuser fins on opposing surfaces of the baseplate, wherein a fluid channels passes through a first diffuser fin on one surface of the baseplate and through a second diffuser fin on the opposing surface of the baseplate to transfer heat from a first gas in contact with the first diffuser fin to a second gas in contact with the second diffuser fin.

11. The heat exchanger of claim 8, wherein the blower is offset from a center of the baseplate.

12. The heat exchanger of claim 8, further configured to perform at least one of: (i) transfer heat from an object coupled to the apparatus to the fluid; and (ii) transfer heat from the fluid to the object.

13. The heat exchanger of claim 8, wherein the fluid is suitable for heat transfer using a single phase of the fluid.

14. The heat exchanger of claim 8, wherein the at least one channel further comprises at least one of: (i) a straight channel; and (ii) a spiral channel.

15. The heat exchanger of claim 8, wherein the at least one channel further comprises a first channel and a second channel, wherein a cross-section of the first channel is different than a cross-section of the second channel.
